(19) United States
(12) Patent Application Publication
(10) Pub. No.: US 2026/0239245 A1
(43) Pub. Date: Aug. 13, 2026

(54) OPERATION BASED ON MULTIPLE SUB-BANDS

(71) Applicant: Samsung Electronics Co., Ltd., Suwon-si (KR)

(72) Inventors: Hongbo Si, Allen, TX (US); Ebrahim MolavianJazi, San Jose, CA (US); Aristides Papasakellariou, Houston, TX (US); Marian Rudolf, Longueuil (CA); Emad Nader Farag, Flanders, NJ (US)

(21) Appl. No.: 19/457,084

(22) Filed: Jan. 22, 2026

Related U.S. Application Data
(60) Provisional application No. 63/757,552, filed on Feb. 12, 2025.

(51) Int. Cl. H04W 56/00; H04L 27/26; H04W 72/0457; H04W 72/231

(52) U.S. Cl. CPC H04W 56/0015; H04L 27/26025; H04W 72/0457; H04W 72/231

(57) ABSTRACT

Apparatuses and methods for operation based on multiple sub-bands. A method performed by a user equipment (UE) in a wireless communication system includes receiving a synchronization signals and physical broadcast channel (SS/PBCH) block in a cell and identifying a first initial bandwidth part (iBWP) based on the SS/PBCH block. The method further includes receiving a system information block, based on the first iBWP and identifying, based on the system information block, a set of sub-bands associated with the cell. The first iBWP is within a first sub-band in the set of sub-bands. The set of sub-bands do not overlap in a frequency domain.

### CROSS-REFERENCE TO RELATED AND CLAIM OF PRIORITY

The present application claims priority under 35 U.S.C. § 119(e) to U.S. Provisional Patent Application No. 63/757,552 filed on Feb. 12, 2025, which is hereby incorporated by reference in its entirety.

### TECHNICAL FIELD

The present disclosure relates generally to wireless communication systems and, more specifically, the present disclosure is related to apparatuses and methods of operation based on multiple sub-bands.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to operation based on multiple sub-bands.

In one embodiment, a user equipment (UE) in a wireless communication system is provided. The UE includes a transceiver configured to receive a synchronization signals and physical broadcast channel (SS/PBCH) block in a cell and a processor operably coupled to the transceiver. The processor is configured to identify a first initial bandwidth part (iBWP) based on the SS/PBCH block. The transceiver is further configured to receive a system information block, based on the first iBWP. The processor is further configured to identify, based on the system information block, a set of sub-bands associated with the cell. The first iBWP is within a first sub-band in the set of sub-bands. The set of sub-bands do not overlap in a frequency domain.

In another embodiment, a method of a UE in a wireless communication system is provided. The method includes receiving a SS/PBCH block in a cell and identifying a first iBWP based on the SS/PBCH block. The method further includes receiving a system information block, based on the first iBWP and identifying, based on the system information block, a set of sub-bands associated with the cell. The first iBWP is within a first sub-band in the set of sub-bands. The set of sub-bands do not overlap in a frequency domain.

In yet another embodiment, a base station (BS) in a wireless communication system is provided. The BS includes a processor configured to determine a first iBWP and determine a set of sub-bands associated with a cell. The first iBWP is within a first sub-band in the set of sub-bands. The set of sub-bands do not overlap in a frequency domain. The BS further includes a transceiver operably coupled to the processor. The transceiver is configured to transmit a SS/PBCH block in the cell and transmit a system information block, based on the first iBWP. The SS/PBCH block includes a first configuration for the first iBWP. The system information block includes a second configuration for the set of sub-bands.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates example configurations of operation with multiple sub-bands according to embodiments of the present disclosure;

FIG. 6 illustrates an example of operation based on multiple initial bandwidth parts (i-BWP) according to embodiments of the present disclosure;

FIG. 7 illustrates an example of operation based on a single i-BWP across multiple sub-bands according to embodiments of the present disclosure;

FIG. 8 illustrates an example UE procedure for operation based on multiple sub-bands according to embodiments of the present disclosure;

FIG. 9 illustrates another example UE procedure for operation based on multiple sub-bands according to embodiments of the present disclosure; and

FIG. 10 illustrates an example method performed by a UE in a wireless communication system according to embodiments of the present disclosure.

### DETAILED DESCRIPTION

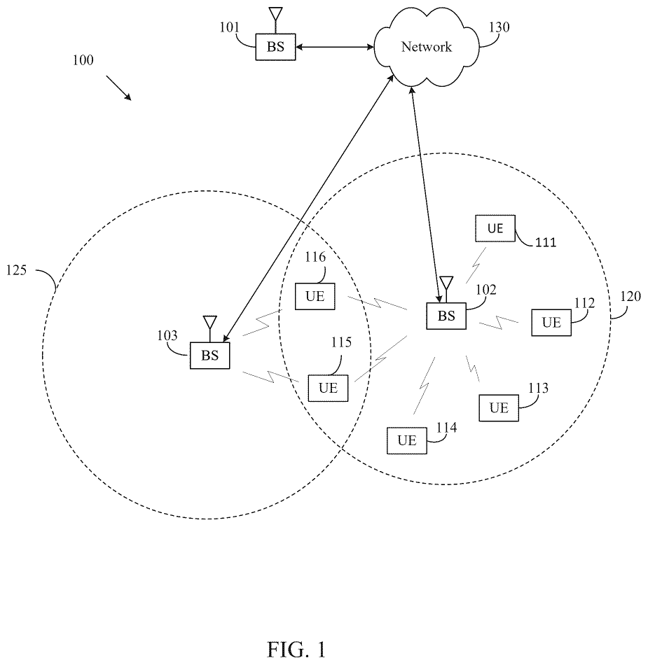

FIGS. 1-10 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211v 16.6.0, “NR; Physical channels and modulation;” [REF 2] 3GPP TS 38.212v 16.6.0 , “NR; Multiplexing and channel coding”; [REF 3] 3GPP TS 38.213v 16.6.0, “NR; Physical layer procedures for control;” [REF 4] 3GPP TS 38.214v 16.6.0 , “NR; Physical layer procedures for data;” [REF 5] 3GPP TS 38.331v 16.5.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for operation based on multiple sub-bands. In certain embodiments, one or more of the BSs 101-103 include circuitry, programing, or a combination thereof to support operation based on multiple sub-bands.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

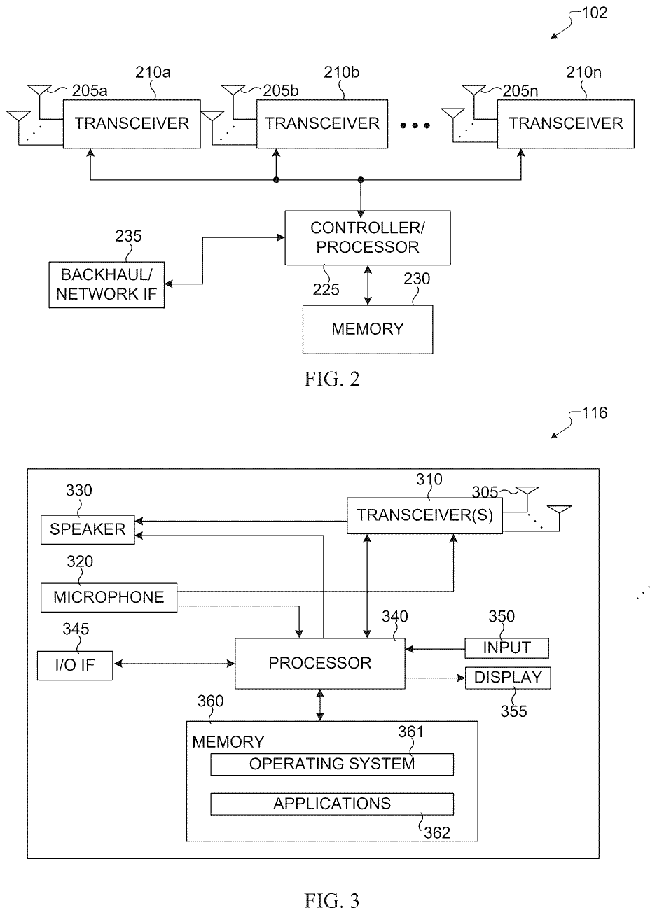

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for operation based on multiple sub-bands. Any of a wide variety of other functions could be supported in the gNB 102 by the controller/processor 225.

The controller/processor 225 is also capable of executing programs and other processes resident in the memory 230, such as processes to support operation based on multiple sub-bands. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for operation based on multiple sub-bands as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

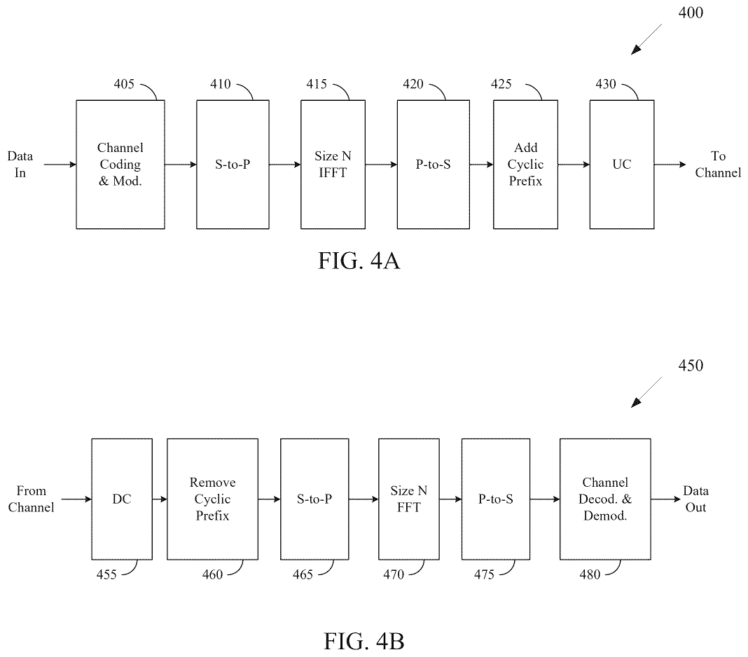

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for operation based on multiple sub-bands as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

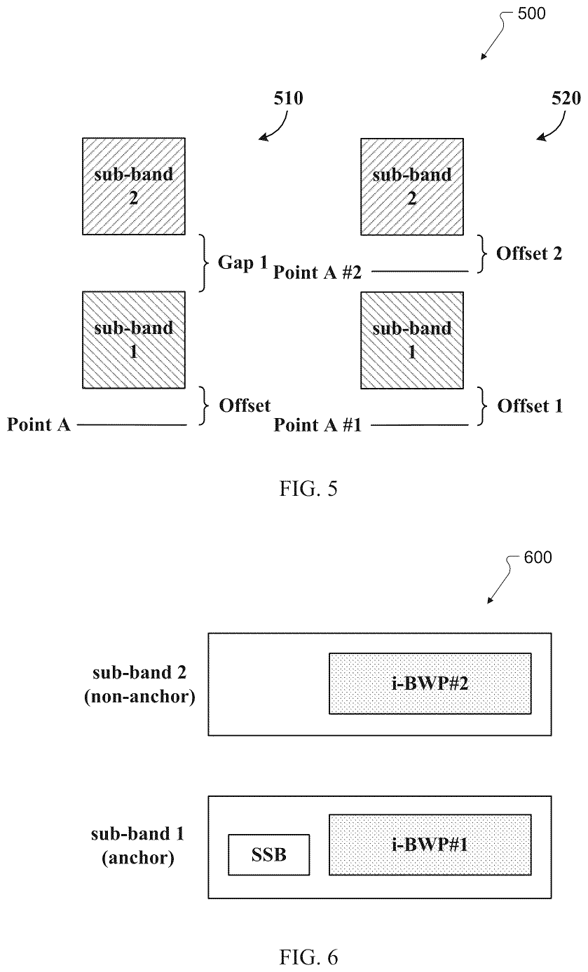

FIG. 5 illustrates example configurations of operation with multiple sub-bands 500 according to embodiments of the present disclosure. For example, the operation with multiple sub-bands 500 can be utilized by any of the UEs 111-116 of FIG. 1, such as the UE 116. This example is for illustration only and other embodiments can be used without departing from the scope of the present disclosure. Although two sub-bands are illustrated in FIG. 5, the example configurations can be generalized to more than two sub-bands. The terminology of sub-band can also be referred to as carrier, or frequency component, or frequency range, or bandwidth component, or carrier component, or cell component.

For a first example configuration (510 in FIG. 5), the configuration can include a common reference starting frequency (e.g., denoted as Point A, and its frequency location can be denoted as f_{A}) for all the sub-bands. A lowest sub-band (e.g., denoted as sub-band with index i with i=1) has an offset (e.g., denoted as O) from Point A. A sub-band other than the lowest sub-band (e.g., denoted as sub-band with index i with i>1) has a gap (e.g., denoted as Gᵢ₋₁) from its lower sub-band (e.g., denoted as sub-band with index i−1). A bandwidth of sub-band with index i is denoted as Sᵢ. A number of sub-bands in the configuration can be denoted as I, such that Sᵢ is with 1≤i≤I, and Gᵢ is with 1≤i≤I−1.

For one sub-example, f_{A} can be configured, e.g., in a system information block (such as SIB1 or SIBx where x>1), and/or in a dedicated RRC parameter (such as a serving cell configuration).

For another sub-example, f_{A} can be pre-determined, e.g., per frequency band. For one further implementation, the pre-determined value can be applied when the configuration of f_{A} is not provided.

For yet another sub-example, f_{A} can correspond to an absolute frequency, e.g., a channel raster entry.

For one sub-example, a common subcarrier spacing (SCS) can be configured or pre-determined for all sub-bands, e.g., applied for at least one of O, and/or at least one value in Si, and/or at least one value in Gᵢ. For one further implementation, the common subcarrier spacing can be configured in system information block (such as SIB1 or SIBx where x>1), and/or in dedicated RRC parameter (such as a serving cell configuration).

For another sub-example, a dedicated subcarrier spacing can be configured or pre-determine per sub-band, e.g., a SCS with index i can be associated with sub-band within index i. For one further implementation, the dedicated subcarrier spacing can be configured in system information block (such as SIB1 or SIBx where x>1), and/or in dedicated RRC parameter (such as a serving cell configuration). For another further implementation, SCS with index i>1 can be applicable to at least one of Sᵢ and/or Gᵢ₋₁. For yet another further implementation, SCS with index i=1 can be applicable to at least one of Sᵢ and/or O. For yet another further implementation, SCS with index i can be applicable to Gᵢ.

For one sub-example, O can be configured, e.g., in system information block (such as SIB1 or SIBx where x>1), and/or in dedicated RRC parameter (such as a serving cell configuration).

For another sub-example, O can be pre-determined, e.g., per frequency band. For one further implementation, the pre-determined value can be applied when the configuration of O is not provided. For another further implementation, O can be pre-determined as 0.

For yet another sub-example, a unit of O can be a SCS, e.g., O is an integer value in the unit of the SCS. For one instance, the SCS corresponds to the SCS of the lowest sub-band (e.g., sub-band with index 1). For another instance, the SCS corresponds to the minimum SCS of all the sub-bands. For yet another instance, the SCS corresponds to the maximum SCS of all the sub-bands. For yet another instance, the SCS corresponds to the common SCS for all the sub-bands.

For yet another sub-example, a unit of O can be a resource block (RB), e.g., O is an integer value in the unit of the RB. For one instance, the SCS of the RB corresponds to the SCS of the lowest sub-band (e.g., sub-band with index 1). For another instance, the SCS of the RB corresponds to the minimum SCS of all the sub-bands. For yet another instance, the SCS of the RB corresponds to the maximum SCS of all the sub-bands. For yet another instance, the SCS of the RB corresponds to the common SCS for all the sub-bands.

For one sub-example, Gᵢ can be configured, e.g., in system information block (such as SIB1 or SIBx where x>1), and/or in dedicated RRC parameter (such as a serving cell configuration).

For another sub-example, Gᵢ can be pre-determined, e.g., per frequency band. For one further implementation, the pre-determined value can be applied when the configuration of Gᵢ is not provided. For another further implementation, Gᵢ can be pre-determined as 0. For yet another further implementation, Gᵢ can be pre-determined as a fixed value in the specification for system operation, e.g., determined based on a minimum requirement on guard band between two consecutive sub-bands. For yet another further implementation, Gᵢ can have a requirement on a minimum value (e.g., a minimum value requirement on the guard band between two consecutive sub-bands). For yet another further implementation, Gᵢ can have a requirement on a maximum value (e.g., a maximum value requirement on the distance between two consecutive sub-bands).

For yet another sub-example, Gᵢ can be a common value for all i. For one instance, if Gᵢ is configured, then a common configuration is applied to all gaps between sub-bands. For another instance, if Gᵢ is pre-determined, then a common pre-determined value is applied to all gaps between sub-bands.

For yet another sub-example, Gᵢ can be associated with a value of i, and can be same or different for different value of i. For one instance, if Gᵢ is configured, then a separate configuration is applied to a gap between two consecutive sub-bands. For another instance, if Gᵢ is pre-determined, then a separate pre-determined value is applied to a gap between two consecutive sub-bands.

For yet another sub-example, a unit of Gᵢ can be a SCS, e.g., Gᵢ is an integer value in the unit of the SCS. For one instance, the SCS corresponds to the SCS of the lower sub-band (e.g., sub-band with index i). For another instance, the SCS corresponds to the SCS of the higher sub-band (e.g., sub-band with index i+1). For yet another instance, the SCS corresponds to the minimum SCS of all the sub-bands. For yet another instance, the SCS corresponds to the maximum SCS of all the sub-bands. For yet another instance, the SCS corresponds to the common SCS for all the sub-bands.

For yet another sub-example, a unit of Gi can be a RB, e.g., Gᵢ is an integer value in the unit of the RB. For one instance, the SCS of the RB corresponds to the SCS of the lower sub-band (e.g., sub-band with index i). For another instance, the SCS of the RB corresponds to the SCS of the higher sub-band (e.g., sub-band with index i+1). For yet another instance, the SCS of the RB corresponds to the minimum SCS of all the sub-bands. For yet another instance, the SCS of the RB corresponds to the maximum SCS of all the sub-bands. For yet another instance, the SCS of the RB corresponds to the common SCS for all the sub-bands.

For one sub-example, Sᵢ can be configured, e.g., in system information block (such as SIB1 or SIBx where x>1), and/or in dedicated RRC parameter (such as a serving cell configuration).

For another sub-example, Sᵢ can be pre-determined, e.g., per frequency band. For one further implementation, the pre-determined value can be applied when the configuration of Sᵢ is not provided. For another further implementation, Sᵢ can be pre-determined as a fixed value in the specification for system operation, e.g., determined based on a maximum transmission or system operation bandwidth of the associated sub-band. For yet another further implementation, Sᵢ can have a requirement on a minimum value (e.g., a minimum value requirement on the bandwidth of a sub-band). For yet another further implementation, Sᵢ can have a requirement on a maximum value (e.g., a maximum value requirement on the bandwidth of a sub-band).

For yet another sub-example, Sᵢ can be a common value for all i. For one instance, if Sᵢ is configured, then a common configuration is applied to all sub-bands. For another instance, if Sᵢ is pre-determined, then a common pre-determined value is applied to all sub-bands.

For yet another sub-example, Sᵢ can be associated with a value of i, and can be same or different for different value of i. For one instance, if Sᵢ is configured, then a separate configuration is applied to a sub-band. For another instance, if Sᵢ is pre-determined, then a separate pre-determined value is applied to a sub-band.

For yet another sub-example, a unit of Sᵢ can be a SCS, e.g., Sᵢ is an integer value in the unit of the SCS. For one instance, the SCS corresponds to the SCS of the sub-band (e.g., sub-band with index i). For another instance, the SCS corresponds to the minimum SCS of all the sub-bands. For yet another instance, the SCS corresponds to the maximum SCS of all the sub-bands. For yet another instance, the SCS corresponds to the common SCS for all the sub-bands.

For yet another sub-example, a unit of Sᵢ can be a RB, e.g., Sᵢ is an integer value in the unit of the RB. For one instance, the SCS of the RB corresponds to the SCS of the sub-band (e.g., sub-band with index i). For another instance, the SCS of the RB corresponds to the minimum SCS of all the sub-bands. For yet another instance, the SCS of the RB corresponds to the maximum SCS of all the sub-bands. For yet another instance, the SCS of the RB corresponds to the common SCS for all the sub-bands.

For a second example configuration (520 in FIG. 5), the configuration can include a dedicated reference starting frequency (e.g., denoted as Point A #i to be associated with sub-band with index i, and its frequency location can be denoted as f_{A,i}) for a sub-band. A sub-band (e.g., denoted as sub-band with index i) has an offset (e.g., denoted as Oᵢ) from its associated Point A. A bandwidth of sub-band with index i is denoted as Sᵢ. A number of sub-bands in the configuration can be denoted as I, such that Sᵢ is with 1≤i≤I, and Oᵢ is with 1≤i≤I.

For one sub-example, f_{A,i} can be configured, e.g., in a system information block (such as SIB1 or SIBx where x>1), and/or in dedicated RRC parameter (such as a serving cell configuration),.

For another sub-example, f_{A,i} can be pre-determined, e.g., per frequency band. For one further implementation, the pre-determined value can be applied when the configuration of f_{A,i} is not provided.

For yet another sub-example, f_{A,i} can correspond to an absolute frequency, e.g., a channel raster entry.

For one sub-example, a common subcarrier spacing (SCS) can be configured for all sub-bands, e.g., applied for at least one of Oᵢ, and/or at least one value in Sᵢ. For one further implementation, the common subcarrier spacing can be configured in system information block (such as SIB1 or SIBx where x>1), and/or in dedicated RRC parameter (such as a serving cell configuration).

For another sub-example, a dedicated subcarrier spacing can be configured per sub-band, e.g., a SCS with index i can be associated with sub-band within index i. For one further implementation, the dedicated subcarrier spacing can be configured in system information block (such as SIB1 or SIBx where x>1), and/or in dedicated RRC parameter (such as a serving cell configuration). For another further implementation, SCS with index i can be applicable to at least one of Sᵢ and/or Oᵢ.

For one sub-example, Oᵢ can be configured, e.g., in system information block (such as SIB1 or SIBx where x>1), and/or in dedicated RRC parameter (such as a serving cell configuration).

For another sub-example, Oᵢ can be pre-determined, e.g., per frequency band. For one further implementation, the pre-determined value can be applied when the configuration of Oᵢ is not provided. For another further implementation, Oᵢ can be pre-determined as 0. For yet another further implementation, Oᵢ can be pre-determined as a fixed value in the specification for system operation, e.g., determined based on a minimum requirement on guard band between two sub-bands.

For yet another sub-example, Oᵢ can be a common value for all i. For one instance, if Oᵢ is configured, then a common configuration is applied to all sub-bands. For another instance, if Oᵢ is pre-determined, then a common pre-determined value is applied to all sub-bands.

For yet another sub-example, Oᵢ can be associated with a value of i, and can be same or different for different value of i. For one instance, if Oᵢ is configured, then a separate configuration is applied to the sub-band with index i. For another instance, if Oᵢ is pre-determined, then a separate pre-determined value is applied to the sub-band with index i.

For yet another sub-example, a unit of Oᵢ can be a SCS, e.g., Oᵢ is an integer value in the unit of the SCS. For one instance, the SCS corresponds to the SCS of the sub-band (e.g., sub-band with index i). For another instance, the SCS corresponds to the minimum SCS of all the sub-bands. For yet another instance, the SCS corresponds to the maximum SCS of all the sub-bands. For yet another instance, the SCS corresponds to the common SCS for all the sub-bands.

For yet another sub-example, a unit of Oᵢ can be a resource block (RB), e.g., Oᵢ is an integer value in the unit of the RB. For one instance, the SCS of the RB corresponds to the SCS of the sub-band (e.g., sub-band with index i). For another instance, the SCS of the RB corresponds to the minimum SCS of all the sub-bands. For yet another instance, the SCS of the RB corresponds to the maximum SCS of all the sub-bands. For yet another instance, the SCS of the RB corresponds to the common SCS for all the sub-bands.

For one sub-example, Sᵢ can be configured, e.g., in system information block (such as SIB1 or SIBx where x>1), and/or in dedicated RRC parameter (such as a serving cell configuration).

For another sub-example, Sᵢ can be pre-determined, e.g., per frequency band. For one further implementation, the pre-determined value can be applied when the configuration of Sᵢ is not provided. For another further implementation, Sᵢ can be pre-determined as a fixed value in the specification for system operation, e.g., determined based on a maximum transmission or system operation bandwidth of the associated sub-band.

For yet another sub-example, Sᵢ can be a common value for all i. For one instance, if Sᵢ is configured, then a common configuration is applied to all sub-bands. For another instance, if Sᵢ is pre-determined, then a common pre-determined value is applied to all sub-bands.

For yet another sub-example, Sᵢ can be associated with a value of i, and can be same or different for different value of i. For one instance, if Sᵢ is configured, then a separate configuration is applied to a sub-band. For another instance, if Sᵢ is pre-determined, then a separate pre-determined value is applied to a sub-band.

For yet another sub-example, a unit of Sᵢ can be a SCS, e.g., Sᵢ is an integer value in the unit of the SCS. For one instance, the SCS corresponds to the SCS of the sub-band (e.g., sub-band with index i). For another instance, the SCS corresponds to the minimum SCS of all the sub-bands.

For yet another instance, the SCS corresponds to the maximum SCS of all the sub-bands. For yet another instance, the SCS corresponds to the common SCS for all the sub-bands.

For yet another sub-example, a unit of Sᵢ can be a RB, e.g., Sᵢ is an integer value in the unit of the RB. For one instance, the SCS of the RB corresponds to the SCS of the sub-band (e.g., sub-band with index i). For another instance, the SCS of the RB corresponds to the minimum SCS of all the sub-bands. For yet another instance, the SCS of the RB corresponds to the maximum SCS of all the sub-bands. For yet another instance, the SCS of the RB corresponds to the common SCS for all the sub-bands.

For a third example, combination of the first example and the second example can be supported, e.g., for some of the sub-bands, the first example configuration is applied, and for the remaining of the sub-bands, the second example configuration is applied.

FIG. 6 illustrates an example of operation based on multiple initial bandwidth parts (i-BWP) 600 according to embodiments of the present disclosure. For example, the operation based on multiple i-BWP 600 can be utilized by any of the UEs 111-116 of FIG. 1, such as the UE 116. This example is for illustration only and other embodiments can be used without departing from the scope of the present disclosure.

For one example, as shown in FIG. 6, at least one sub-band of the multiple sub-bands can include a signal or channel for initial access purpose (e.g., time and/or frequency domain synchronization and/or system information delivery), and a UE can be provided with a bandwidth in each of the multiple sub-bands for receiving further common signal or channel and/or transmitting uplink signal or channel for initial access.

For one sub-example, the signal or channel for initial access purpose can be synchronization signals and/or physical broadcast channel (SS/PBCH) block (SSB).
For one instance, the SSB can be associated with a system information block (e.g., SIB1), which can also be referred as cell-defining SSB (CD-SSB).
For another instance, the SSB can be located on a synchronization raster entry in the frequency domain.

For another sub-example, the bandwidth in each of the multiple sub-bands can be referred as an initial bandwidth part (i-BWP).
For one instance, the i-BWP can be either a downlink i-BWP or an uplink i-BWP. When the configurations of downlink i-BWP and uplink i-BWP are different (e.g., for FDD operation), each of the configurations of downlink i-BWP and uplink i-BWP can be according to an example or sub-example in this disclosure.

For one sub-example, the at least one sub-band including the signal or channel for initial access purpose can be referred as an anchor sub-band. For one further implementation, the anchor sub-band can be any sub-band within the multiple sub-bands.

For another sub-example, a sub-band not including the signal or channel for initial access purpose can be referred as a non-anchor sub-band.

For one sub-example, for a given anchor sub-band (e.g., denoted as sub-band with index k), the SSB associated with the anchor sub-band can provide a configuration of the i-BWP (e.g., denoted as i-BWP #k) in the sub-band with index k. For a further implementation, a system information block (e.g., SIB1) to be received in the i-BWP #k can include at least configuration(s) of the i-BWP(s) in other sub-bands (e.g., non-anchor sub-band(s)). For another further implementation, the system information block (e.g., SIB1) to be received in the i-BWP #k can also include configuration of the i-BWP #k (e.g., the anchor sub-band) in addition to configuration(s) of the i-BWP(s) in other sub-bands (e.g., non-anchor sub-band(s)), e.g., configuration(s) of all the i-BWPs.
For one instance, the configuration of the i-BWP #k can include a number of RBs of the i-BWP #k.
For another instance, the configuration of the i-BWP #k can include a RB offset (e.g., N_{offset}) between the RB overlapping with the lowest RB of the SSB and the lowest RB of the i-BWP (or CORESET to monitor Type0-PDCCH).
For yet another instance, the configuration of the i-BWP #k can include a subcarrier offset (e.g., k_{SSB}) between the first subcarrier of the first RB of the SSB and the first subcarrier of the common RB that overlapping with the first subcarrier of the first RB of the SSB.
For yet another instance, the configuration can also include time domain information on the search space set to monitor PDCCH for system information block (e.g., Type0-PDCCH).
For yet another instance, the configuration can be included in the master information block (MIB) of the SSB.

For another sub-example, for a given anchor sub-band (e.g., denoted as sub-band with index k), the SSB associated with the anchor sub-band can provide configuration(s) of all the i-BWPs.

For one sub-example, some configuration(s) of all the i-BWPs can be common.
For one instance, the configuration on the time domain information on the search space set to monitor PDCCH for system information block (e.g., Type0-PDCCH) can be common for all the i-BWPs.
For another instance, the configuration on the number of OFDM symbols for the CORESET to monitor PDCCH for system information block (e.g., Type0-PDCCH) can be common for all the i-BWPs.
For yet another instance, the configuration on the subcarrier spacing for the CORESET to monitor PDCCH for system information block (e.g., Type0-PDCCH) can be common for all the i-BWPs.
For yet another instance, the configuration on the number of RBs for the CORESET to monitor PDCCH for system information block (e.g., Type0-PDCCH) can be common for all the i-BWPs.
   For yet another instance, the configuration on the kSSB can be common for all the i-BWPs.

For one sub-example, configuration(s) of all the i-BWPs can include K sets of sub-configurations, wherein K is the number of i-BWPs.
For one instance, each set of sub-configurations is associated with a sub-band, and includes a number of RBs for the CORESET to monitor Type0-PDCCH on the associated sub-band, and a RB offset (e.g., N_{offset}) between the RB overlapping with the lowest RB of the SSB and the lowest RB of CORESET to monitor Type0-PDCCH on the associated sub-band.
For another instance, each set of sub-configurations is associated with a sub-band, and includes a value of k_{SSB} for the sub-band, a number of RBs for the CORESET to monitor Type0-PDCCH on the associated sub-band, and a RB offset (e.g., N_{offset}) between the RB overlapping with the lowest RB of the SSB and the lowest RB of CORESET to monitor Type0-PDCCH on the associated sub-band.
For yet another instance, one set of sub-configurations is associated with the anchor sub-band, which includes a number of RBs for the CORESET to monitor Type0-PDCCH, and a RB offset (e.g., N_{offset}) between the RB overlapping with the lowest RB of the SSB and the lowest RB of CORESET to monitor Type0-PDCCH on the anchor sub-band; and each set in the remaining set of sub-configurations is associated with one of the remaining sub-band, which includes a number of RBs for the CORESET to monitor Type0-PDCCH, and a RB offset (e.g., N_{offset}) between the lowest RB of CORESET to monitor Type0-PDCCH on anchor sub-band and the lowest RB of CORESET to monitor Type0-PDCCH on the associated sub-band.
For yet another instance, one set of sub-configurations is associated with the anchor sub-band, which includes a value of k_{SSB} for the anchor sub-band, a number of RBs for the CORESET to monitor Type0-PDCCH, and a RB offset (e.g., N_{offset}) between the RB overlapping with the lowest RB of the SSB and the lowest RB of CORESET to monitor Type0-PDCCH on the anchor sub-band; and each set in the remaining set of sub-configurations is associated with one of the remaining sub-band, which includes a value of k_{SSB} for the associated sub-band, a number of RBs for the CORESET to monitor Type0-PDCCH, and a RB offset (e.g., N_{offset}) between the lowest RB of CORESET to monitor Type0-PDCCH on anchor sub-band and the lowest RB of CORESET to monitor Type0-PDCCH on the associated sub-band.
For yet another instance, each set of sub-configurations is associated with a sub-band, and includes a starting RB for the i-BWP comparing to the lowest RB of the associated sub-band, and a number of RB as the bandwidth of the i-BWP.
For yet another instance, each set of sub-configurations is associated with a sub-band, and includes a value of k_{SSB} for the associated sub-band, a starting RB for the i-BWP comparing to the lowest RB of the associated sub-band, and a number of RB as the bandwidth of the i-BWP.

For another sub-example, configuration(s) of all the i-BWPs can include a configuration for frequency information of all the CORESETs in the sub-bands.
For one instance, the frequency information includes a RB offset (e.g., N_{offset}) between the RB overlapping with the lowest RB of the SSB and the lowest RB of CORESET to monitor Type0-PDCCH on the lowest sub-band.
For another instance, the frequency information includes a number of RBs as bandwidth for each sub-band.
For yet another instance, the frequency information includes a number of RBs as gap between each two consecutive sub-bands.
For yet another instance, the frequency information includes a value of k_{SSB}.
For yet another instance, the configuration(s) further include an indication on which sub-band is the anchor sub-band or which CORESET is associated with the anchor sub-band.
For yet another instance, the UE can determine the CORESET overlapping with the SSB is the CORESET associated with the anchor sub-band.

For one sub-example, configuration(s) of all the remaining i-BWPs (e.g., other than the i-BWP in anchor sub-band) can include K−1 sets of sub-configurations, wherein K is the number of i-BWPs.
For one instance, each set of sub-configurations is associated with a sub-band, and includes a number of RBs for the CORESET to monitor Type0-PDCCH on the associated sub-band, and a RB offset (e.g., N_{offset}) between the RB overlapping with the lowest RB of the SSB and the lowest RB of CORESET to monitor Type0-PDCCH on the associated sub-band.
For another instance, each set of sub-configurations is associated with a sub-band, and includes a value of k_{SSB} for the sub-band, a number of RBs for the CORESET to monitor Type0-PDCCH on the associated sub-band, and a RB offset (e.g., N_{offset}) between the RB overlapping with the lowest RB of the SSB and the lowest RB of CORESET to monitor Type0-PDCCH on the associated sub-band.
For yet another instance, each set of sub-configurations is associated a sub-band, and includes a number of RBs for the CORESET to monitor Type0-PDCCH, and a RB offset (e.g., N_{offset}) between the lowest RB of CORESET to monitor Type0-PDCCH on anchor sub-band and the lowest RB of CORESET to monitor Type0-PDCCH on the associated sub-band.
For yet another instance, each set of sub-configurations is associated a sub-band, and includes a value of k_{SSB} for the associated sub-band, a number of RBs for the CORESET to monitor Type0-PDCCH, and a RB offset (e.g., N_{offset}) between the lowest RB of CORESET to monitor Type0-PDCCH on anchor sub-band and the lowest RB of CORESET to monitor Type0-PDCCH on the associated sub-band.
For yet another instance, each set of sub-configurations is associated with a sub-band, and includes a starting RB for the i-BWP comparing to the lowest RB of the associated sub-band, and a number of RB as the bandwidth of the i-BWP.
For yet another instance, each set of sub-configurations is associated with a sub-band, and includes a value of k_{SSB} for the associated sub-band, a starting RB for the i-BWP comparing to the lowest RB of the associated sub-band, and a number of RB as the bandwidth of the i-BWP.

For one sub-example, a UE can determine at least one from the multiple i-BWPs to use.
For one instance, the determination can be based on UE identity and/or pre-defined UE grouping information.
For another instance, the determination can be based on an indication in the SSB (e.g., PBCH payload, or DM-RS of PBCH, or SSS, or a sync signal included in the SSB).
For yet another instance, the determination can be based on an indication in the Type0-PDCCH.
For yet another instance, the determination can be based on an indication in the system information block (such as SIB1 or SIBx where x>1).

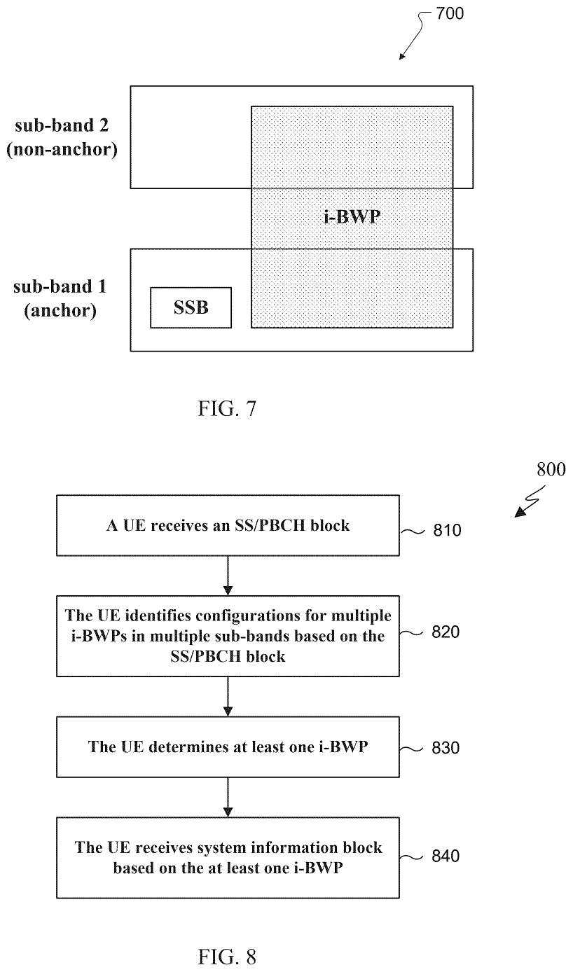

FIG. 7 illustrates an example of operation based on a single i-BWP across multiple sub-bands 700 according to embodiments of the present disclosure. For example, the operation based on single i-BWP across multiple sub-bands 700 can be utilized by any of the UEs 111-116 of FIG. 1, such as the UE 116. This example is for illustration only and other embodiments can be used without departing from the scope of the present disclosure.

For one example, as shown in FIG. 7, at least one sub-band of the multiple sub-bands can include a signal or channel for initial access purpose (e.g., time and/or frequency domain synchronization and/or system information delivery), and a UE can be provided with a bandwidth across multiple sub-bands for receiving further common signal or channel and/or transmitting uplink signal or channel for initial access.

For one sub-example, the signal or channel for initial access purpose can be synchronization signals and/or physical broadcast channel (SS/PBCH) block (SSB).
For one instance, the SSB can be associated with a system information block (e.g., SIB1), which can also be referred as cell-defining SSB (CD-SSB).
For another instance, the SSB can be located on a synchronization raster entry in the frequency domain.

For another sub-example, the bandwidth in each of the multiple sub-bands can be referred as an initial bandwidth part (i-BWP).
For one instance, the i-BWP can be either a downlink i-BWP or an uplink i-BWP. When the configurations of downlink i-BWP and uplink i-BWP are different (e.g., for FDD operation), each of the configurations of downlink i-BWP and uplink i-BWP can be according to an example or sub-example in this disclosure.

For one sub-example, the at least one sub-band including the signal or channel for initial access purpose can be referred as an anchor sub-band. For one further implementation, the anchor sub-band can be any sub-band within the multiple sub-bands.

For another sub-example, a sub-band not including the signal or channel for initial access purpose can be referred as a non-anchor sub-band.

For one sub-example, for a given anchor sub-band (e.g., denoted as sub-band with index k), the SSB associated with the anchor sub-band can provide a configuration of an i-BWP (e.g., denoted as i-BWP #k) in the sub-band with index k. For a further implementation, a system information block (e.g., SIB1) to be received in the i-BWP #k can include configuration(s) of the i-BWPs across all sub-bands.
For one instance, the configuration of the i-BWP #k can include a number of RBs of the i-BWP #k.
   For another instance, the configuration of the i-BWP #k can include a RB offset (e.g., N_{offset}) between the RB overlapping with the lowest RB of the SSB and the lowest RB of the i-BWP (or CORESET to monitor Type0-PDCCH).
   For yet another instance, the configuration of the i-BWP #k can include a subcarrier offset (e.g., k_{SSB}) between the first subcarrier of the first RB of the SSB and the first subcarrier of the common RB that overlapping with the first subcarrier of the first RB of the SSB.
   For yet another instance, the configuration can also include time domain information on the search space set to monitor PDCCH for system information block (e.g., Type0-PDCCH).
   For yet another instance, the configuration can be included in the master information block (MIB) of the SSB.

For one sub-example, for a given anchor sub-band (e.g., denoted as sub-band with index k), the SSB associated with the anchor sub-band can provide a configuration of the i-BWP.

For one sub-example, configuration(s) of the i-BWPs can include K sets of sub-configurations, wherein K is the number of i-BWPs.
For one instance, each set of sub-configurations is associated with a sub-band, and includes a number of RBs for the CORESET to monitor Type0-PDCCH on the associated sub-band, and a RB offset (e.g., N_{offset}) between the RB overlapping with the lowest RB of the SSB and the lowest RB of CORESET to monitor Type0-PDCCH on the associated sub-band.
For another instance, each set of sub-configurations is associated with a sub-band, and includes a value of k_{SSB} for the sub-band, a number of RBs for the CORESET to monitor Type0-PDCCH on the associated sub-band, and a RB offset (e.g., N_{offset}) between the RB overlapping with the lowest RB of the SSB and the lowest RB of CORESET to monitor Type0-PDCCH on the associated sub-band.
For yet another instance, one set of sub-configurations is associated with the anchor sub-band, which includes a number of RBs for the CORESET to monitor Type0-PDCCH, and a RB offset (e.g., N_{offset}) between the RB overlapping with the lowest RB of the SSB and the lowest RB of CORESET to monitor Type0-PDCCH on the anchor sub-band; and each set in the remaining set of sub-configurations is associated with one of the remaining sub-band, which includes a number of RBs for the CORESET to monitor Type0-PDCCH, and a RB offset (e.g., N_{offset}) between the lowest RB of CORESET to monitor Type0-PDCCH on anchor sub-band and the lowest RB of CORESET to monitor Type0-PDCCH on the associated sub-band.
For yet another instance, one set of sub-configurations is associated with the anchor sub-band, which includes a value of k_{SSB} for the anchor sub-band, a number of RBs for the CORESET to monitor Type0-PDCCH, and a RB offset (e.g., N_{offset}) between the RB overlapping with the lowest RB of the SSB and the lowest RB of CORESET to monitor Type0-PDCCH on the anchor sub-band; and each set in the remaining set of sub-configurations is associated with one of the remaining sub-band, which includes a value of k_{SSB} for the associated sub-band, a number of RBs for the CORESET to monitor Type0-PDCCH, and a RB offset (e.g., N_{offset}) between the lowest RB of CORESET to monitor Type0-PDCCH on anchor sub-band and the lowest RB of CORESET to monitor Type0-PDCCH on the associated sub-band.
For yet another instance, each set of sub-configurations is associated with a sub-band, and includes a starting RB for the i-BWP comparing to the lowest RB of the associated sub-band, and a number of RB as the bandwidth of the i-BWP.
For yet another instance, each set of sub-configurations is associated with a sub-band, and includes a value of k_{SSB} for the associated sub-band, a starting RB for the i-BWP comparing to the lowest RB of the associated sub-band, and a number of RB as the bandwidth of the i-BWP.

For another sub-example, configuration(s) of the i-BWP can include a configuration for frequency information of all the sub-bands.
For one instance, the frequency information includes a RB offset (e.g., N_{offset}) between the RB overlapping with the lowest RB of the SSB and the lowest RB of CORESET to monitor Type0-PDCCH on the lowest sub-band.
For another instance, the frequency information includes a number of RBs as bandwidth for each sub-band.
For yet another instance, the frequency information includes a number of RBs as gap between each two consecutive sub-bands.
For yet another instance, the frequency information includes a value of k_{SSB}.
For yet another instance, the configuration(s) further include an indication on which sub-band is the anchor sub-band or which CORESET is associated with the anchor sub-band.
For yet another instance, the UE can determine the CORESET overlapping with the SSB is the CORESET associated with the anchor sub-band.

For yet another sub-example, configuration(s) of the i-BWP can include a configuration for frequency information of all the sub-bands.
For one instance, the frequency information includes a RB offset (e.g., N_{offset}) between the RB overlapping with the lowest RB of the SSB and the lowest RB of CORESET to monitor Type0-PDCCH on the lowest sub-band.
For another instance, the frequency information includes a number of RBs as bandwidth of the i-BWP across multiple sub-bands.
For yet another instance, the frequency information includes a value of k_{SSB}.
For yet another instance, the configuration(s) further include an indication on which sub-band is the anchor sub-band or which CORESET is associated with the anchor sub-band.
For yet another instance, the UE can determine the CORESET overlapping with the SSB is the CORESET associated with the anchor sub-band.
For yet another instance, based on the configuration of sub-bands, the UE can determine which resources are included in the gap between two consecutive sub-bands.

For one sub-example, a UE can determine resources in at least one from the multiple sub-bands to use.
For one instance, the determination can be based on UE identity and/or pre-defined UE grouping information.
For another instance, the determination can be based on an indication in the SSB (e.g., PBCH payload)
For yet another instance, the determination can be based on an indication in the Type0-PDCCH.
For yet another instance, the determination can be based on an indication in the system information block (such as SIB1 or SIBx where x>1).

For one sub-example, the UE can assume the resources in the gap(s) between two consecutive sub-bands (e.g., RBs or subcarriers in Gᵢ) are available for downlink reception, e.g., PDCCH and/or PDSCH of system information block or RAR or paging are not using those resources.

For another sub-example, the UE can assume the resources in the gap(s) between two consecutive sub-bands (e.g., RBs or subcarriers in Gᵢ) are available for uplink transmission, e.g., PRACH occasion or PUSCH occasion is not valid if overlapping with such resources, and/or PRACH or msgA, or msg3 are not transmitted in those resources.

For one sub-example, for a given UE, its transmission and/or reception in the i-BWP can be restricted to one sub-band. For instance, the mapping and/or resource allocation of one downlink reception or one uplink transmission is confined within the resources in one sub-band.

For another sub-example, for a given UE, its transmission and/or reception in the i-BWP can be across sub-bands. For instance, the mapping and/or resource allocation of one downlink reception or one uplink transmission can be based on multiple the sub-bands (e.g., all the sub-bands in the i-BWP), e.g., rate matching around the resources in gap(s), and/or puncturing the resources in gap(s).

FIG. 8 illustrates an example UE procedure 800 for operation based on multiple sub-bands according to embodiments of the present disclosure. The procedure 800 of FIG. 8 can be performed by any of the UEs 111-116 of FIG. 1, such as the UE 116 of FIG. 3, and a corresponding method can be performed by any of the BSs 101-103 of FIG. 1, such as BS 102 of FIG. 2. The procedure 800 is for illustration only and other embodiments can be used without departing from the scope of the present disclosure.

The procedure 800 begins with a UE, such as UE 116 of FIG. 3, receives a synchronization signal/physical broadcast channel (SS/PBCH) block (810). The UE then identifies configurations for multiple i-BWPs in multiple sub-bands based on the SS/PBCH block (820). The UE then determines at least one i-BWP (830). The UE then receives a system information block based on the at least one i-BWP (840).

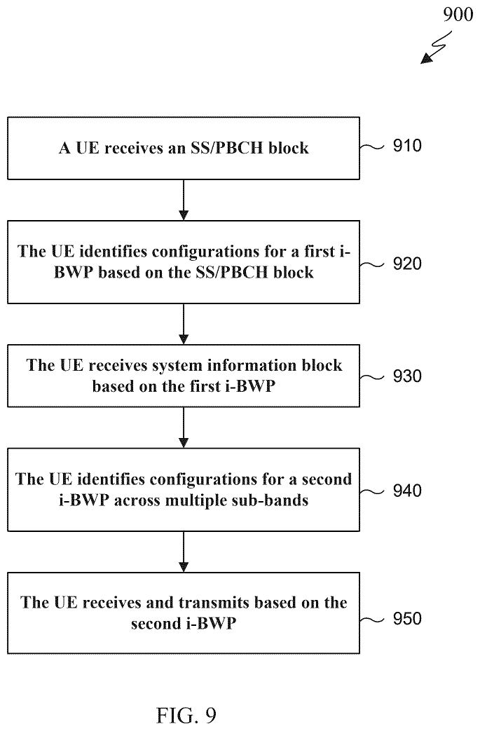

FIG. 9 illustrates another example UE procedure 900 for operation based on multiple sub-bands according to embodiments of the present disclosure. The procedure 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The procedure 900 is for illustration only and other embodiments can be used without departing from the scope of the present disclosure.

The procedure 900 begins with the UE receiving an SS/PBCH block (910). The UE then identifies configurations for a first i-BWP based on the SS/PBCH block (920). The UE then receives a system information block based on the first i-BWP (930). The UE then identifies configurations for a second i-BWP across multiple sub-bands (940). The UE then receives and transmits based on the second i-BWP (950).

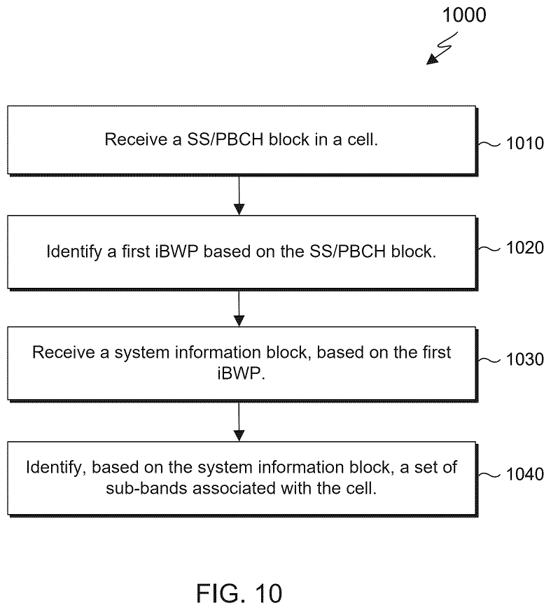

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method 1000 begins with the UE receiving a SS/PBCH block in a cell (1010). The UE then identifies a first iBWP based on the SS/PBCH block (1020). The UE then receives a system information block, based on the first iBWP (1030).

The UE then identifies, based on the system information block, a set of sub-bands associated with the cell (1040). For example, in 1040, the first iBWP is within a first sub-band in the set of sub-bands, and the set of sub-bands do not overlap in a frequency domain. In various embodiments, the sub-bands in the set of sub-bands are associated with a same subcarrier spacing. In various embodiments, a lowest sub-band in the set of sub-bands starts with a frequency offset with respect to a reference frequency, and the frequency offset and the reference frequency are provided by the system information block. In various embodiments, each sub-band in the set of sub-bands has a bandwidth of an integer number of consecutive RBs, and the integer number is provided by the system information block. In various embodiments, a gap between two neighboring sub-bands in the set of sub-bands is an integer number of consecutive RBs, and the integer number is provided by the system information block.

In various embodiments, the UE determines a first configuration of a second iBWP based on the system information block. The second iBWP is within a second sub-band in the set of sub-bands, and the first and second sub-bands are different. In various embodiments, the UE determines, based on the system information block, a second configuration of a physical random access preamble to be transmitted in the second iBWP, and a third configuration of a physical downlink control channel (PDCCH) to be monitored in the second iBWP.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a synchronization signals and physical broadcast channel (SS/PBCH) block in a cell; and
a processor operably coupled to the transceiver, the processor configured to identify a first initial bandwidth part (iBWP) based on the SS/PBCH block,
wherein the transceiver is further configured to receive a system information block, based on the first iBWP,
wherein the processor is further configured to identify, based on the system information block, a set of sub-bands associated with the cell, and
wherein:
the first iBWP is within a first sub-band in the set of sub-bands; and
the set of sub-bands do not overlap in a frequency domain.

2. The UE of claim 1, wherein the sub-bands in the set of sub-bands are associated with a same subcarrier spacing.

3. The UE of claim 1, wherein:
a lowest sub-band in the set of sub-bands starts with a frequency offset with respect to a reference frequency, and
the frequency offset and the reference frequency are provided by the system information block.

4. The UE of claim 1, wherein:
each sub-band in the set of sub-bands has a bandwidth of an integer number of consecutive resource blocks (RBs), and
the integer number is provided by the system information block.

5. The UE of claim 1, wherein:
a gap between two neighboring sub-bands in the set of sub-bands is an integer number of consecutive resource blocks (RBs), and
the integer number is provided by the system information block.

6. The UE of claim 1, wherein:
the processor is further configured to determine a first configuration of a second iBWP based on the system information block,
the second iBWP is within a second sub-band in the set of sub-bands, and
the first and second sub-bands are different.

7. The UE of claim 6, wherein the processor is further configured to determine, based on the system information block, (i) a second configuration of a physical random access preamble to be transmitted in the second iBWP, and (ii) a third configuration of a physical downlink control channel (PDCCH) to be monitored in the second iBWP.

8. A method of a user equipment (UE) in a wireless communication system, the method comprising:
receiving a synchronization signals and physical broadcast channel (SS/PBCH) block in a cell;
identifying a first initial bandwidth part (iBWP) based on the SS/PBCH block;
receiving a system information block, based on the first iBWP; and
identifying, based on the system information block, a set of sub-bands associated with the cell, wherein:
the first iBWP is within a first sub-band in the set of sub-bands, and
the set of sub-bands do not overlap in a frequency domain.

9. The method of claim 8, wherein the sub-bands in the set of sub-bands are associated with a same subcarrier spacing.

10. The method of claim 8, wherein:
a lowest sub-band in the set of sub-bands starts with a frequency offset with respect to a reference frequency, and
the frequency offset and the reference frequency are provided by the system information block.

11. The method of claim 8, wherein:
each sub-band in the set of sub-bands has a bandwidth of an integer number of consecutive resource blocks (RBs), and
the integer number is provided by the system information block.

12. The method of claim 8, wherein:
a gap between two neighboring sub-bands in the set of sub-bands is an integer number of consecutive resource blocks (RBs), and
the integer number is provided by the system information block.

13. The method of claim 8, further comprising:
determining a first configuration of a second iBWP based on the system information block, wherein:
the second iBWP is within a second sub-band in the set of sub-bands, and
the first and second sub-band are different.

14. The UE of claim 13, further comprising determining, based on the system information block, (i) a second configuration of a physical random access preamble to be transmitted in the second iBWP, and (ii) a third configuration of a physical downlink control channel (PDCCH) to be monitored in the second iBWP.

15. A base station (BS) in a wireless communication system, the BS comprising:
a processor configured to:
determine a first initial bandwidth part (iBWP);
determine a set of sub-bands associated with a cell, wherein:
the first iBWP is within a first sub-band in the set of sub-bands, and
the set of sub-bands do not overlap in a frequency domain; and
a transceiver operably coupled to the processor, the transceiver configured to:
transmit a synchronization signals and physical broadcast channel (SS/PBCH) block in the cell, wherein the SS/PBCH block includes a first configuration for the first iBWP; and
transmit a system information block, based on the first iBWP, wherein the system information block includes a second configuration for the set of sub-bands.

16. The BS of claim 15, wherein the sub-bands in the set of sub-bands are associated with a same subcarrier spacing.

17. The BS of claim 15, wherein:
a lowest sub-band in the set of sub-bands starts with a frequency offset with respect to a reference frequency, and
the frequency offset and the reference frequency are included in the system information block.

18. The BS of claim 15, wherein:
each sub-band in the set of sub-bands has a bandwidth of an integer number of consecutive resource blocks (RBs), and
the integer number is included in the system information block.

19. The BS of claim 15, wherein:
a gap between two neighboring sub-bands in the set of sub-bands is an integer number of consecutive resource blocks (RBs), and
the integer number is included in the system information block.

20. The BS of claim 15, wherein the processor is further configured to:
determine a third configuration of a second iBWP, wherein:
the second iBWP is within a second sub-band in the set of sub-bands, and
the first and second sub-band are different;
determine a fourth configuration of a physical random access preamble to be received in the second iBWP; and
determine a fifth configuration of a physical downlink control channel (PDCCH) to be transmitted in the second iBWP,
wherein the third, fourth, and fifth configurations are included in the system information block.
